(19) United States
(12) Patent Application Publication
(10) Pub. No.: US 2008/0169769 A1
(43) Pub. Date: Jul. 17, 2008

(54) MULTI-LAMPS DRIVING DEVICE AND TRANSFORMER THEREOF

(76) Inventor: Huang-Chih LEE, Taoyuan Hsien (TW)

Correspondence Address: BIRCH STEWART KOLASCH & BIRCH, PO BOX 747, FALLS CHURCH, VA, 22040-0747, US

(21) Appl. No.: 11/971,740

(22) Filed: Jan. 9, 2008

(30) Foreign Application Priority Data
Jan. 11, 2007 (TW) 096101099

(51) Int. Cl. H05B 41/14; H01F 27/02; H01F 27/24; H01F 27/28

(52) U.S. Cl. 315/278; 336/170; 336/90; 315/324

(57) ABSTRACT

A transformer includes a first bobbin, a second bobbin, a primary winding and at least four secondary windings. The first bobbin has a first primary winding area and at least two first secondary winding areas. The first primary winding area is located between the first secondary winding areas. The second bobbin is combined with the first bobbin and has a second primary winding area and at least two second secondary winding areas. The second primary winding area is located between the second secondary winding areas. The primary winding is wound around the first primary winding area and the second primary winding area. The secondary windings are respectively wound around the first secondary winding areas and the second secondary winding areas.

### CROSS REFERENCE TO RELATED APPLICATIONS

This Non-provisional application claims priority under 35 U.S.C. §119(a) on Patent Application No(s). 096101099 filed in Taiwan, Republic of China on Jan. 11, 2007, the entire contents of which are hereby incorporated by reference.

### BACKGROUND OF THE INVENTION

1. Field of Invention

The invention relates to a transformer and a driving device and in particular, to a multi-winding transformer and a lamp driving device.

2. Related Art

A backlight module of a liquid crystal display usually includes lamps, such as cold cathode fluorescent lamps (CCFLs), serving as a light source. In order to ensure the lamps to have uniform luminance, a driving circuit for the lamps has to provide uniform current to each of the lamps.

Referring to FIG. 1, a driving device 1 drives a plurality of lamps 2 and includes a driving circuit 11, a transformer 12 and a plurality of capacitors 13. The driving circuit 11 provides a power to a primary side of the transformer 12 so that the transformer 12 transforms the power for the lamps 2 and outputs the transformed power from a secondary side. The capacitors 13 are electrically connected to and between the lamps 2 and the transformer 12, respectively. Because the lamps in the parallel paths do not have exactly equivalent impedance, the transformer 12 cannot provide the same current on each of the paths. In order to solve this problem, the capacitors 13 are matched with the lamps 2 so that the equivalent impedances in the parallel paths are the same and the same current can flow through each of the paths.

In the conventional architecture, however, the capacitors 13 on the paths are not completely the same so that the equivalent impedances of each of the parallel paths are not the same, and the currents flowing through the lamps 2 are not the same. Thus, the luminances of the lamps 2 are not the same.

In addition, when the single transformer 12 outputs the power to the lamps 2 in the conventional architecture, the difference between the currents to each of the lamps 2 is very great. The single transformer 12 has to provide the current for the single lamp 2 in order to control the current of the lamp precisely. Consequently, the cost of the overall driving device is increased greatly.

Furthermore, when the single transformer 12 outputs the power to the lamps 2, other balancing circuits have to be utilized so that the currents flowing through the lamps 2 are the same. However, the additional balancing circuits not only occupy space on the circuit board but also increase the manufacturing cost.

Thus, it is an important subject of the invention to provide a driving device for a transformer to prevent the above-mentioned problems and avoid the above-mentioned drawbacks.

### SUMMARY OF THE INVENTION

In view of the foregoing, the invention is to provide a transformer capable of driving multiple lamps, and a driving device thereof.

To achieve the above, the invention discloses a transformer including a first bobbin, a second bobbin, a primary winding and a plurality of secondary windings. The first bobbin has a first primary winding area and at least two first secondary winding areas. The second bobbin is combined with the first bobbin and has a second primary winding area and at least two second secondary winding areas. The primary winding is wound around the first primary winding area and the second primary winding area. The secondary windings are wound around the first secondary winding areas and the second secondary winding areas, respectively.

To achieve the above, the invention also discloses a multi-lamp driving device for driving a plurality of lamps. The multi-lamp driving device includes a driving circuit and a transformer. The transformer has a first bobbin, a second bobbin, a primary winding and a plurality of secondary windings. The first bobbin has a first primary winding area and at least two first secondary winding areas, and the first primary winding area is disposed between the first secondary winding areas. The second bobbin is combined with the first bobbin and has a second primary winding area and at least two second secondary winding areas, and the second primary winding area is disposed between the second secondary winding areas. The primary winding is wound around the first and second primary winding areas, and is electrically connected to the driving circuit. The secondary windings are wound around the first and second secondary winding areas, respectively, and electrically connected to the lamps, respectively.

As mentioned above, in the transformer and the multi-lamp driving device according to the invention, the transformer has a plurality of secondary windings for driving a plurality of corresponding lamps. The single transformer can drive the lamps, and the currents flowing through the lamps may be the same.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a schematic illustration showing a conventional driving device;

FIG. 2 is a schematic illustration showing a transformer according to an embodiment of the invention;

FIGS. 3 to 10 are schematic illustrations showing various modifications of the core assembly of the transformer of FIG. 2; and

FIGS. 11 to 13 are schematic illustrations showing multi-lamp driving devices according to an embodiment of the invention.

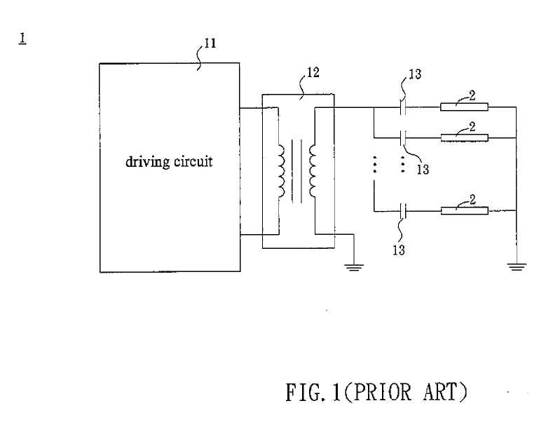

### DETAILED DESCRIPTION OF THE INVENTION

The present invention will be apparent from the following detailed description, which proceeds with reference to the accompanying drawings, wherein the same references relate to the same elements.

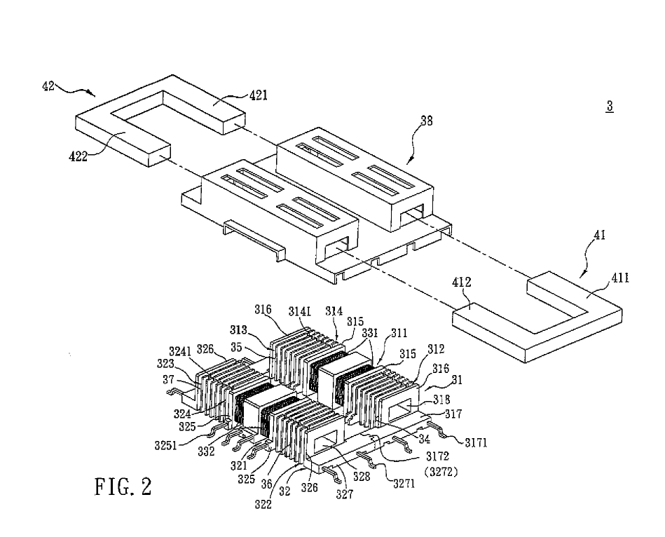

Referring to FIG. 2, a transformer 3 according to an embodiment of the present invention includes a first bobbin 31, a second bobbin 32, primary windings 331 and 332 and secondary windings 34, 35, 36 and 37. The first bobbin 31 has a first primary winding area 311 and at least two first secondary winding areas 312 and 313. The first primary winding area 311 is disposed between the first secondary winding areas 312 and 313. The second bobbin 32 is combined with the first bobbin 31 and has a second primary winding area 321 and at least two second secondary winding areas 322 and 323. The second primary winding area 321 is disposed between the second secondary winding areas 322 and 323. The primary windings 331 and 332 are wound around the first primary winding area 311 and the second primary winding area 321. The secondary windings 34, 35, 36 and 37 are wound around the first secondary winding areas 312 and 313 and the second secondary winding areas 322 and 323, respectively.

In this embodiment, the numbers of wires of the secondary windings 34, 35, 36 and 37 are the same so that the ratios of the wires of the primary windings 331 and 332 to those of the secondary windings 34, 35, 36 and 37 are the same. The primary windings 331 and 332 serve as the primary side winding set of the transformer 3, and the secondary windings 34, 35, 36 and 37 serve as the secondary side winding set of the transformer 3.

In this embodiment, the two primary windings 331 and 332 are wound around the first and second primary winding areas 311, 321, respectively. The primary windings 331 and 332 are electrically connected to each other. The numbers of wires of the primary windings 331 and 332 are the same. In addition, in another embodiment, one single primary winding may be simultaneously wound around the first and second primary winding areas 311, 321.

The transformer further includes a housing 38 covering the first and second bobbins 31, 32, and the coils on the bobbins.

The first bobbin 31 further includes a plurality of first insulation plates 314 and a plurality of first stopping plates 315 and 316. The first insulation plates 314 are disposed in the first secondary winding areas 312 and 313 to separate the wires of the secondary windings 34 and 35 correspondingly. An upper edge of the first insulation plate 314 is formed with a notch 3141 through which the secondary windings 34 and 35 pass correspondingly. The first stopping plate 315 is disposed in the first primary winding area 311 and has one pin (not shown). The primary winding 331 is wound on one side of the first stopping plate 315. The pin is connected to the corresponding primary winding 331.

The second bobbin 32 further includes a plurality of second insulation plates 324 and a plurality of second stopping plates 325 and 326. The second insulation plates 324 are disposed in the second secondary winding areas 322 and 323 and separate the wires of the secondary windings 36 and 37 correspondingly. A notch 3241 is formed on an upper edge of the second insulation plate 324. The secondary windings 36 and 37 pass through the notch 3241. The second stopping plate 325 is disposed in the second primary winding area 321 and has a pin 3251. The primary winding 332 is wound on one side of the second stopping plate 325. The pin 3251 is connected to the corresponding primary winding 332.

The first bobbin 31 further includes at least one first base 317 disposed on a lateral side of the first bobbin 31, and respectively has a plurality of first pins 3171 electrically connected to the secondary windings 34 and 35. The second bobbin 32 further includes at least one second base 327 disposed on a lateral side of the second bobbin 32, and respectively has a plurality of second pins 3271 electrically connected to the secondary windings 36 and 37. The first base 317 has a convex portion 3172, and the second base 327 has a concave portion 3272 correspondingly combined with the convex portion 3172.

The first stopping plate 315, the second stopping plate 325, the first base 317 or the second base 327 may have a wire guiding slot for containing and stabilizing a portion of wires of the primary winding 331 or 332 and the secondary winding 34, 35, 36 or 37. The wire guiding slot may be formed on the front side, the backside or other surfaces of the first stopping plate 315, the second stopping plate 325, the first base 317 or the second base 327.

The first bobbin 31 has a first hollow portion 318, the second bobbin 32 has a second hollow portion 328, and the transformer 3 further includes a first core and a second core, which respectively or simultaneously pass through the first hollow portion 318 and the second hollow portion 328. The first core and the second core provide magnetic loops so that the secondary windings 34, 35, 36 and 37 can sense changes of magnetic fields of the primary windings 331 and 332 to generate induction currents.

In this embodiment, two finger-shaped cores 41 and 42 have a plurality of finger-shaped portions 411, 412 and 421, 422, respectively. The finger-shaped portions 411 and 421 pass through the first hollow portion 318 and contact each other. The finger-shaped portions 412 and 422 pass through the second hollow portion 328 and contact each other.

The finger-shaped cores 41 and 42 serve as the first core and the second core of the transformer 3. In addition to the patterns mentioned hereinabove, the first core or the second core can also be clubbed, U, I, H, E or multi-finger shape. When the first core or the second core has a multi-finger shape with more than two fingers, at least one finger of the first core or the second core may not pass through the first hollow portion 318 and the second hollow portion 328.

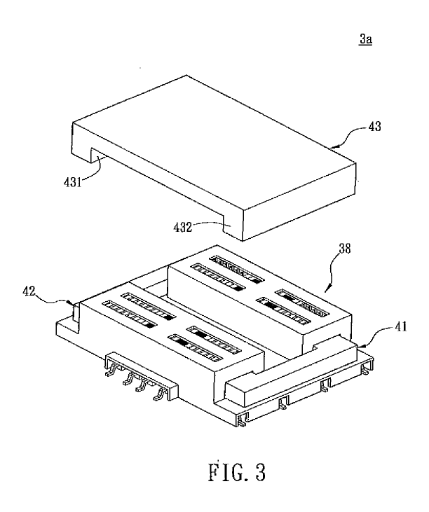

However, the assembled pattern of the core assembly 4 is not limited thereto, and various assembled patterns are shown in FIGS. 3 to 10.

Referring to FIG. 3, what the difference is in that the transformer 3a further includes a U-shaped core 43, which covers the housing 38 and has two side portions 431 and 432 disposed at two ends of the U-shaped core 43. The side portions 431 and 432 are respectively connected to the finger-shaped cores 41 and 42.

The U-shaped core 43 serves as a third core of the transformer. In addition to the above-mentioned pattern, the third core can be I, clubbed, H, circular, polygonal annular, elliptical or annular shape. Other aspects of these cores will be described with reference to the associated drawings.

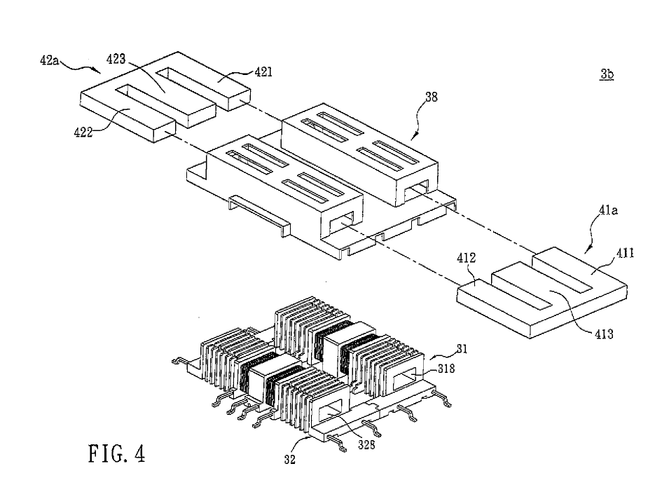

As shown in FIG. 4, what the difference is in that the finger-shaped cores 41a and 42a of the transformer 3b further have finger-shaped portions 413 and 423, respectively, so that the finger-shaped cores 41a and 42a form the depicted E shape. In this embodiment, the finger-shaped portions 411 and 421 pass through the first hollow portion 318, and the finger-shaped portions 412 and 422 pass through the second hollow portion 328. The finger-shaped portions 413 and 423 are disposed between the first and second hollow portions 318, 328 and contact each other.

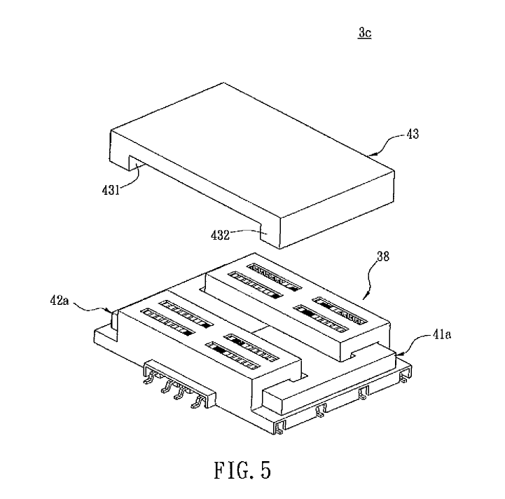

Referring to FIG. 5, what is different from FIG. 4 is that the transformer 3c further includes a U-shaped core 43, which covers the housing 38 and has two side portions 431 and 432 disposed at two ends of the U-shaped core 43. The side portions 431 and 432 are respectively connected to the finger-shaped cores 41a and 42a.

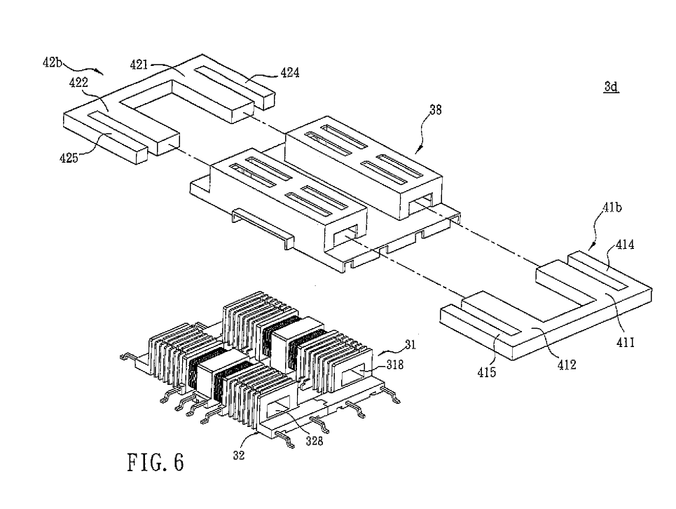

Referring to FIG. 6, what is different from FIG. 2 is that the finger-shaped cores 41b and 42b of the transformer 3d further includes a plurality of finger-shaped portions 414, 415, 424, and 425, respectively, so that the finger-shaped cores 41b and 42b form the depicted multi-finger shape. The finger-shaped portions 411 and 421 pass through the first hollow portion 318, the finger-shaped portions 412 and 422 pass through the second hollow portion 328, the finger-shaped portions 414 and 424 are disposed outside the first bobbin 31, and the finger-shaped portions 415 and 425 are disposed outside the second bobbin 32.

In addition, the transformer 3d can further include a U-shaped core disposed outside the first bobbin 31 and the second bobbin 32, i.e. covered the housing 38. Because the method of combining the U-shaped core with the bobbins is similar to those of FIGS. 3 and 5, detailed structures thereof are not illustrated in the drawing.

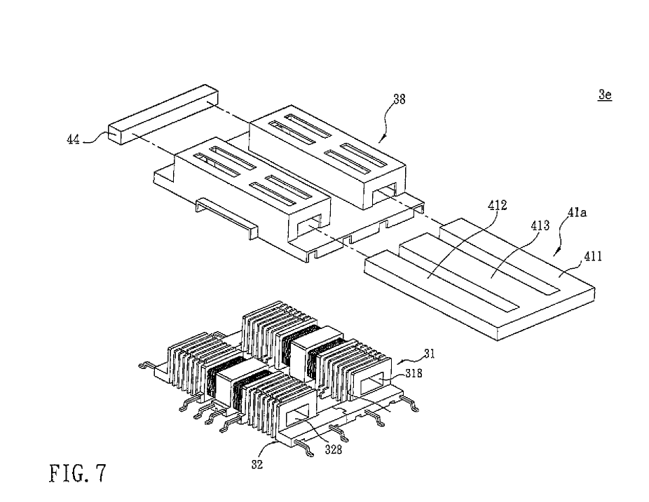

Referring to FIG. 7, what is different from FIG. 4 is that the finger-shaped core 42a of the transformer 3b is replaced with a clubbed shape core 44 of the transformer 3e. The finger-shaped portions 411 and 412 pass through the first and second hollow portions 318, 328, respectively, and connect to the clubbed shape core 44. The finger-shaped core 41a further includes a finger-shaped portion 413 disposed between the first and second hollow portions 318, 328 and connected to the clubbed shape core 44.

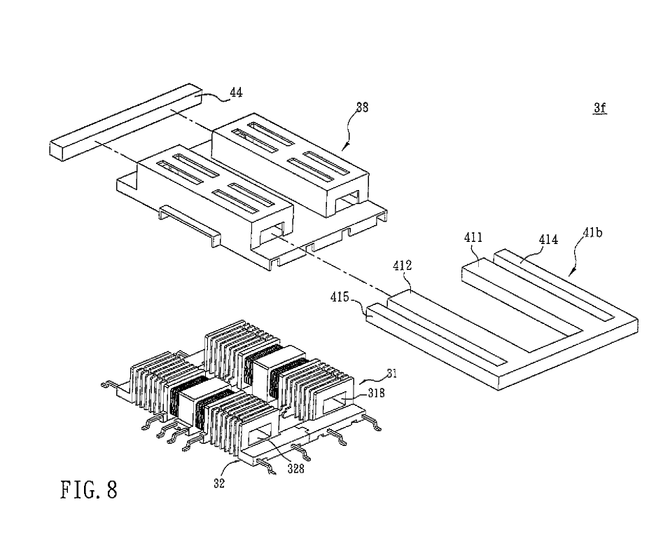

Referring to FIG. 8, what is different from FIG. 7 is that the finger-shaped core 41b of the transformer 3f further includes a plurality of finger-shaped portions 414 and 415. The finger-shaped portion 414 is disposed outside the first bobbin 31, the finger-shaped portion 415 is disposed outside the second bobbin 32, and the finger-shaped portions 414 and 415 are connected to the clubbed shape core 44.

In addition, the transformers 3e and 3f shown in FIGS. 7 and 8 may further include a U-shaped core, which is disposed outside the first bobbin 31 and the second bobbin 32 and has two side portions disposed at two ends of the U-shaped core. The side portions are respectively connected to the clubbed shape core 44 and the finger-shaped core 41a or the finger-shaped core 41b. Because the method of combining the U-shaped core of this aspect with the bobbins is similar to those of FIGS. 3 and 5, detailed structures thereof are not illustrated in the drawing.

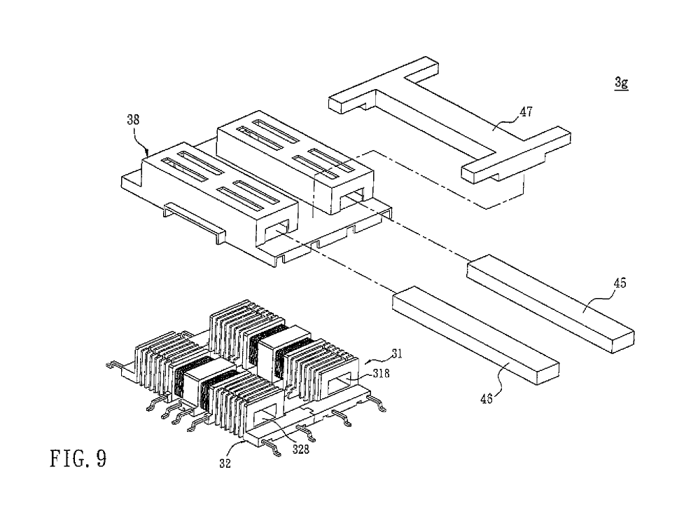

Referring to FIG. 9, what is different from FIG. 2 is that the finger-shaped cores 41 and 42 of the transformer 3 are replaced with clubbed shape cores 45 and 46 of the transformer 3g, respectively. The clubbed shape cores 45 and 46 pass through the first and second hollow portions 318, 328, respectively. The core assembly further includes an H-shaped core 47, which is disposed between the first bobbin 31 and the second bobbin 32, and connected to two ends of the clubbed shape cores 45 and 46.

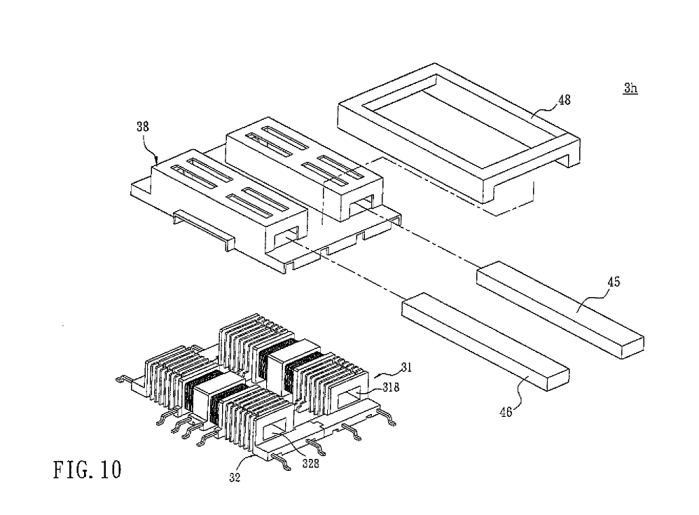

Referring to FIG. 10, what is different from FIG. 9 is that the transformer 3h further includes a core 48 instead of the H-shaped core 47, which is disposed outside the first bobbin 31 and the second bobbin 32, and has two edges connected to the clubbed shape cores 45 and 46. The core 48 can be circular, polygonal annular, elliptical or annular shape.

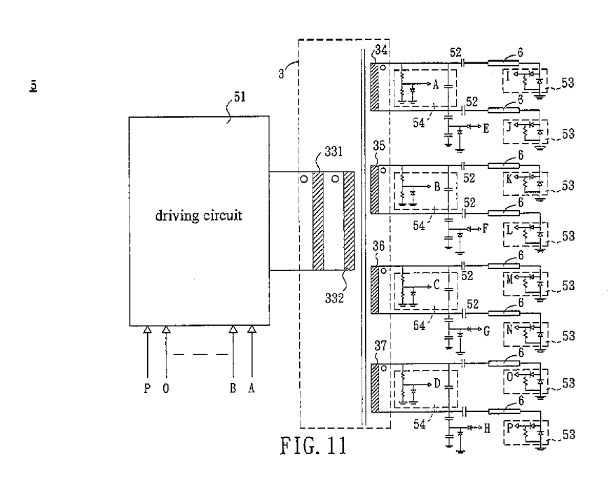

Referring to FIG. 11, a multi-lamp driving device 5 according to an embodiment of the invention drives a plurality of lamps 6 and includes a driving circuit 51 and a transformer as the transformer 3 shown in FIG. 2. The primary windings 331 and 332 are electrically connected to each other and electrically connected to the driving circuit 51. The driving circuit 51 provides power to the primary windings 331 and 332 such that the secondary windings 34, 35, 36 and 37 are induced to generate the current or voltage suitable to drive each of the lamps 6.

In this embodiment, two ends of each of the secondary windings 34, 35, 36 and 37 drive their respective one of the lamps 6. Capacitive elements 52, such as capacitors, are connected to and between their respective secondary windings 34, 35, 36 and 37 and lamps 6 in series. The secondary windings 34, 35, 36 and 37 are connected to their respective resonance circuits 54 in parallel. In addition, a feedback circuit 53 is connected to and between the lamp 6 and the driving circuit 51 in series. The feedback circuit 53 detects a current flowing through the corresponding lamp 6 so that the driving circuit 51 adjusts the power provided therefrom. The lamp 6 is a cold cathode fluorescent lamp (CCFL) or a discharge lamp.

Because the secondary windings 34, 35, 36 and 37 have the same number of wires, the voltages or the currents outputted therefrom are the same so that the currents flowing through the lamps 6 are the same.

In the method of combining the lamps and the transformer, the voltages or the currents outputted by the secondary windings 34, 35, 36 and 37 by way of transformation have the same phase.

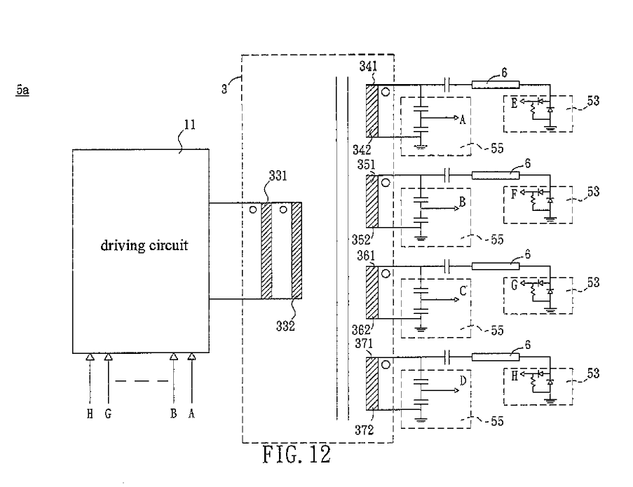

Referring to FIG. 12, what is different from FIG. 11 is that the secondary windings 34, 35, 36 and 37 of the multi-lamp driving device 5a are respectively connected to two capacitive elements 55 in parallel. First ends 341, 351, 361, and 371 of the secondary windings 34, 35, 36 and 37, respectively, are coupled to the lamps 6 to drive the lamps 6, and second ends 342, 352, 362, 372 of the secondary windings 34, 35, 36 and 37, respectively, are grounded. It is possible to commonly ground all the secondary windings 34, 35, 36 and 37 or individually ground the secondary windings.

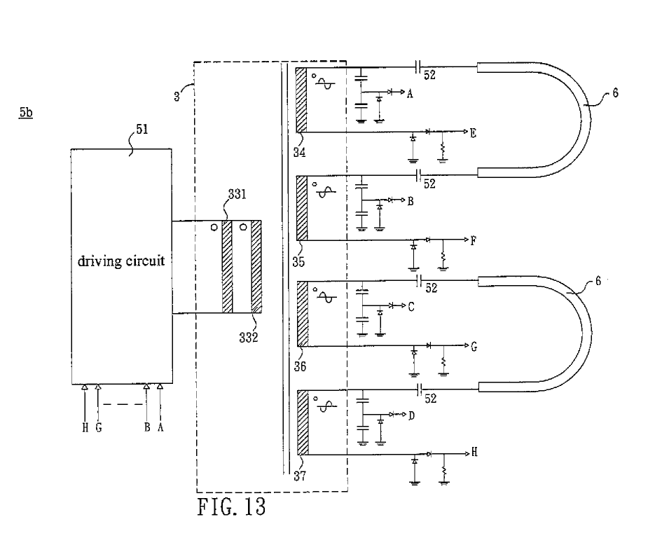

Referring to FIG. 13, what is different from FIG. 11 is that first ends of the secondary windings 34 and 36 of the multi-lamp driving device 5b are coupled to the corresponding first ends of the lamps 6, and first ends of the secondary windings 35 and 37 are coupled to the corresponding second ends of the lamps 6.

According to the method of combining the lamps with the transformer, the voltages or the currents, which are outputted from the secondary windings 34 and 36 by way of transformation and have waveforms, have the same phase. The voltages or currents, which are outputted from the secondary windings 35 and 37 by way of transformation and have waveforms, also have the same phase. The phase difference between the waveforms of the voltages or the currents outputted from the secondary windings 34 and 36 and those outputted from the secondary windings 35 and 37 is preferably 180 degrees.

In summary, in the transformer and the multi-lamp driving device according to the invention, the transformer has a plurality of secondary windings for driving a plurality of corresponding lamps. The single transformer can drive the lamps, and the currents flowing through the lamps may be the same.

Although the invention has bee described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A transformer comprising:
a first bobbin having a first primary winding area and at least two first secondary winding areas;
a second bobbin combined with the first bobbin and having a second primary winding area and at least two second secondary winding areas;
a primary winding wound around the first primary winding area and the second primary winding area; and
a plurality of secondary windings wound around the first secondary winding areas and the second secondary winding areas, respectively.

2. The transformer according to claim 1, wherein the secondary windings have the same number of wires.

3. The transformer according to claim 1, wherein the first bobbin or the second bobbin comprises at least one insulation plate for separating corresponding wires of each of the secondary windings, the insulation plate comprises at least one notch, and the secondary windings pass through the notch.

4. The transformer according to claim 1, wherein the first bobbin or the second bobbin comprises at least one stopping plate, and the primary winding is wound on one side or two sides of the stopping plate, and the stopping plate comprises at least one pin electrically connected to the primary winding and at least one wire guiding slot for containing a portion of wires of the primary winding.

5. The transformer according to claim 1, wherein the first bobbin or the second bobbin comprises at least one base disposed on a lateral side of the first bobbin or a lateral side of the second bobbin, and the base comprises at least one pin electrically connected to at least one of the secondary windings and at least one wire guiding slot for containing a part of the secondary windings.

6. The transformer according to claim 1, wherein the first bobbin and the second bobbin have at least one convex portion and at least one concave portion, respectively, and the convex portion is correspondingly combined with the concave portion.

7. The transformer according to claim 1, further comprising a first core and a second core, which respectively or simultaneously pass through a first hollow portion of the first bobbin and a second hollow portion of the second bobbin.

8. The transformer according to claim 7, wherein when the first core or the second core has a multi-finger shape with more than two fingers, at least one finger of the first core or the second core does not pass through the first hollow portion and the second hollow portion.

9. The transformer according to claim 7, further comprising a third core disposed outside the first bobbin and the second bobbin and connected to the first core and the second core.

10. The transformer according to claim 9, wherein the first core or the second core is clubbed, U-shaped, I-shaped, H-shaped, E-shaped or multi-finger shapes, and the third core is U-shaped, H-shaped, I-shaped, clubbed, circular, annular, polygonal annular or elliptical.

11. The transformer according to claim 1, further comprising a housing covering the first bobbin, the second bobbin, the primary winding and the secondary windings.

12. A multi-lamp driving device for driving a plurality of lamps, comprising:
a driving circuit; and
a transformer having a first bobbin, a second bobbin, a primary winding and a plurality of secondary windings, wherein:
the first bobbin has a first primary winding area and at least two first secondary winding areas;
the second bobbin is combined with the first bobbin and has a second primary winding area and at least two second secondary winding areas;
the primary winding is wound around the first primary winding area and the second primary winding area, and is electrically connected to the driving circuit; and
the secondary windings are wound around the first secondary winding areas and the second secondary winding areas, respectively, and are electrically connected to each of the lamps.

13. The multi-lamp driving device according to claim 12, wherein a capacitive element is connected to and between each of the secondary windings and the lamps in series.

14. The multi-lamp driving device according to claim 12, wherein the secondary windings are connected to a resonance circuit or a capacitive element in parallel.

15. The multi-lamp driving device according to claim 12, wherein first ends of the secondary windings are coupled to first ends of the lamps, respectively, and second ends of the secondary windings are commonly coupled to a node.

16. The multi-lamp driving device according to claim 12, wherein two ends of the lamps are respectively coupled to two ends of different ones of the secondary windings or two ends of the same one of the secondary windings.

17. The multi-lamp driving device according to claim 12, wherein the lamps are cold cathode fluorescent lamps (CCFLs) or discharge lamps.

18. The multi-lamp driving device according to claim 12, wherein the secondary windings generate a voltage or a current with a waveform.

19. The multi-lamp driving device according to claim 12, further comprising a feedback circuit connected to and between the lamps and the driving circuit in series to detect a current flowing through the lamps.

20. The multi-lamp driving device according to claim 12, wherein first ends of the secondary windings are coupled to the lamps to drive the lamps, and second ends of the secondary windings are grounded.
